(19) United States
(12) Patent Application Publication
(10) Pub. No.: US 2020/0322065 A1
(43) Pub. Date: Oct. 8, 2020

(54) Over-The-Air Calibration Of Transmit Power Of Wireless Devices

(71) Applicant: MediaTek Singapore Pte. Ltd., Singapore (SG)

(72) Inventors: Vishal Bhargava, Noida (IN); Rahul Mahajan, Noida (IN); Abhijeet Singh Katiyar, Noida (IN); Tarun Kumar Datta, Noida (IN); Abhijit Uplenchwar, Noida (IN)

(21) Appl. No.: 16/518,985

(22) Filed: Jul. 23, 2019

(30) Foreign Application Priority Data
Apr. 2, 2019 (IN) 201921013319

(51) Int. Cl. H04B 17/00; H04W 24/06; H04W 72/04

(52) U.S. Cl. CPC H04B 17/0085; H04W 72/0473; H04W 72/0446; H04W 24/06

(57) ABSTRACT

An apparatus (e.g., testing instrument) measures one or more parameters related to transmit power in a first wireless signal transmitted by a wireless device which is under test by the apparatus. The apparatus then transmits to the wireless device a second wireless signal containing data of a result of measurement of the one or more parameters. The first wireless signal may be an IEEE 802.11 data frame, and the second wireless signal may be an IEEE 802.11 generic frame.

### CROSS REFERENCE TO RELATED PATENT APPLICATION(S)

The present disclosure is part of a non-provisional patent application claiming the priority benefit of India Patent Application No. 201921013319, filed 2 Apr. 2019, the content of which being incorporated herein by reference in its entirety.

### TECHNICAL FIELD

The present disclosure is generally related to wireless communications and, more particularly, to over-the-air calibration of transmit power of wireless devices.

### BACKGROUND

Unless otherwise indicated herein, approaches described in this section are not prior art to the claims listed below and are not admitted as prior art by inclusion in this section.

Typically, during the time of manufacturing, measurements of transmit power of a wireless device (such as a wireless device designed for wireless communication in accordance with the Institute of Electrical and Electronics Engineers (IEEE) 802.11 specification(s)) are performed. That is, various parameters related to the transmit power of the wireless device under test are measured and the results of which are used in calibration of the wireless device. Generally, a testing instrument is utilized to measure the various parameters related to the transmit power of wireless device under test. The testing instrument then provides measurements results on a user interface thereof (e.g., a web-based or desktop application), and feedback data is provided to the wireless devices under test via a control system. FIG. 4 shows a conventional setup.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose novel schemes, solutions, mechanisms, methods and systems for over-the-air calibration of transmit power of wireless devices. Thus, time spent on testing wireless devices during production may be reduced under various schemes in accordance with the present disclosure. Moreover, the need of control setup and the complexity in setup typically associated with conventional test setups may be avoided or otherwise reduced under various schemes in accordance with the present disclosure.

In one aspect, a method may involve a processor of an apparatus measuring one or more parameters related to transmit power in a first wireless signal transmitted by a wireless device which is under test by the apparatus. The method may also involve the processor transmitting to the wireless device a second wireless signal containing data of a result of measurement of the one or more parameters.

In one aspect, an apparatus may include a communication device and a processor coupled to the communication device. The communication device may be capable of wirelessly receiving and transmitting signals with a wireless device which is under test by the apparatus. The processor may be capable of measuring, via the transceiver, one or more parameters related to transmit power in a first wireless signal transmitted by the wireless device. The processor may also be capable of transmitting, via the transceiver, to the wireless device a second wireless signal containing data of a result of measurement of the one or more parameters.

It is noteworthy that, although description provided herein may be in the context of certain radio access technologies, networks and networking topologies such as IEEE 802.11, the proposed concepts, schemes and any variation(s)/derivative(s) thereof may be implemented in, for and by other types of radio access technologies, networks and network topologies such as, for example and without limitation, Bluetooth, ZigBee, infrared, near-field communication (NFC), 5th Generation (5G), New Radio (NR), Evolved Packet System (EPS), Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 3 is a simplified block diagram of an example apparatus in accordance with an implementation of the present disclosure.

FIG. 3 is a flowchart of an example process in accordance with an implementation of the present disclosure.

FIG. 4 is a diagram of conventional setup for testing a wireless device.

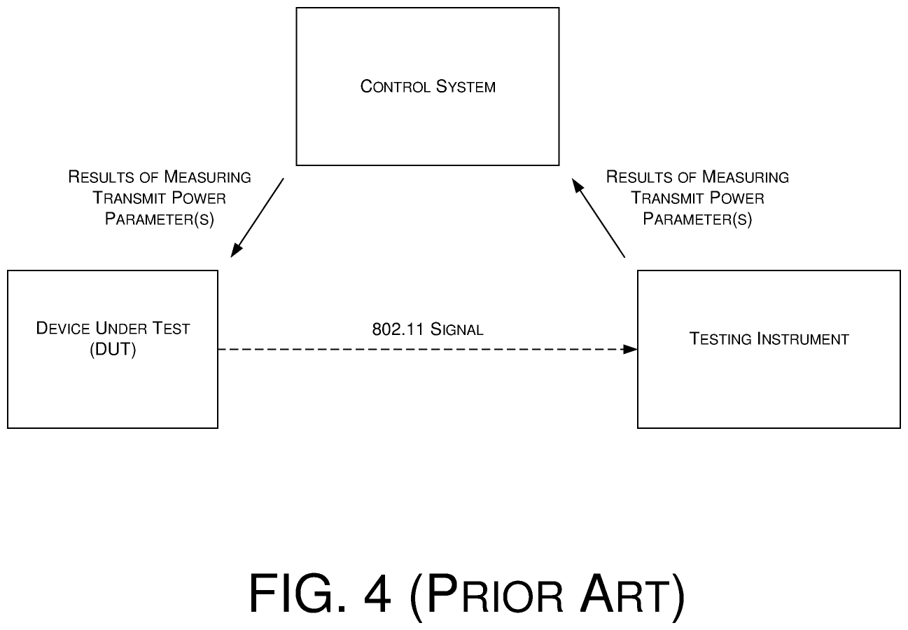

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Under a proposed scheme regarding over-the-air calibration of transmit power of wireless devices in accordance with the present disclosure, data of various parameters related to transmit power of one or more wireless devices may be obtained using a wireless medium (e.g., using IEEE 802.11 frame(s) in accordance with the IEEE 802.11 specification(s)). In contrast, conventional test setups typically need to use some other interface or measurement device(s) to read the data. Under the proposed scheme, a testing instrument used to measure various parameters related to transmit power in wireless signals (e.g., Wi-Fi signals/packets) transmitted by one or more wireless devices may be capable of generating and transmitting wireless signals (e.g., Wi-Fi signals/packets) containing measurement results. The measurement results may pertain to various parameters related to transmit power such as, for example and without limitation, average transmit power, peak transmit power, channel power and error vector magnitude (EVM) data. Accordingly, the one or more wireless devices under test may receive the wireless signals from the testing instrument and perform calibration using the measure results contained in the wireless signals. Under the proposed scheme, any generic Wi-Fi frame may be used to provide to one or more wireless devices under test the measurement results of one or more of the various parameters related to transmit power of the one or more wireless devices under test. Moreover, under the proposed scheme, the wireless device under test may transmit wireless signal(s) in a single packet/frame or multiple packets/frames in any given testing session for measurement by the testing instrument.

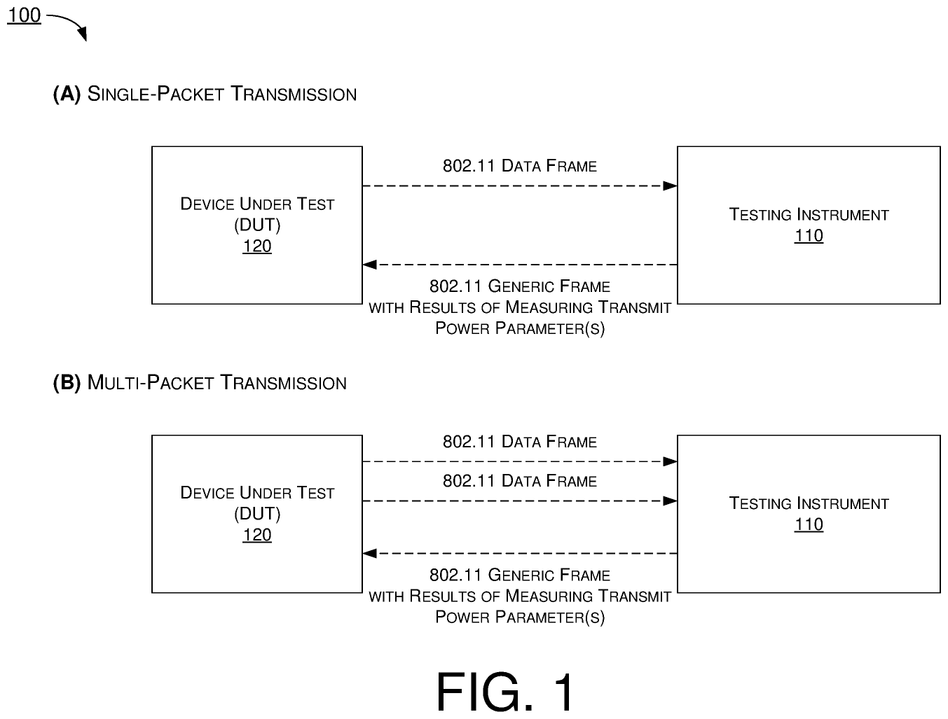

FIG. 1 illustrates an example scenario 100 in accordance with an implementation of the present disclosure. For simplicity, scenario 100 is shown to involve a testing instrument 110 and a single wireless device under test (DUT) 120, although there may be multiple wireless devices under test. In part (A) of FIG. 1, DUT 120 may wireless transmit a single data frame (e.g., IEEE 802.11 data frame) for measurement by testing instrument 110. Upon measuring one or more of various parameters related to the transmit power of DUT 120, testing instrument 110 may wireless transmit a generic frame (e.g., IEEE 802.11 generic frame) containing data of measurement result(s) of one or more of the various parameters related to the transmit power of DUT 120. In part (B) of FIG. 1, DUT 120 may wireless transmit multiple data frames (e.g., IEEE 802.11 data frames) for measurement by testing instrument 110. Upon measuring one or more of various parameters related to the transmit power of DUT 120, testing instrument 110 may wireless transmit a generic frame (e.g., IEEE 802.11 generic frame) containing data of measurement result(s) of one or more of the various parameters related to the transmit power of DUT 120.

In view of the above, those skilled in the art would appreciate that the proposed scheme can reduce production time, especially in a mass-production context. Additionally, by implementing the proposed scheme, there would be less need of control setup and, thus, complexity in testing setup may be reduced. Accordingly, it is believed that those skilled in the art would appreciate the benefits and usefulness to the manufacturing industry by the proposed scheme in accordance with the present disclosure.

### Illustrative Implementations

FIG. 2 illustrates an example apparatus 200 in accordance with an implementation of the present disclosure. Apparatus 200 may perform various functions to implement schemes, techniques, processes and methods described herein pertaining to over-the-air calibration of transmit power of wireless devices in accordance with the present disclosure. Apparatus 200 may be a part of an electronic apparatus which may be a testing instrument, a communication device, a computing apparatus, a portable or mobile apparatus, or a wearable apparatus. Alternatively, apparatus 200 may be implemented in the form of one or more integrated-circuit (IC) chips such as, for example and not limited to, one or more single-core processors, one or more multi-core processors, or one or more complex-instruction-set-computing (CISC) processors. Apparatus 200 may include at least those components shown in FIG. 2, such as a processor 210. Additionally, apparatus 200 may include a communication device 230 which may include a wireless transceiver. Communication device 230 may be configured to transmit and receive data wirelessly (e.g., in compliance with the IEEE 802.11 specification and/or any applicable wireless protocols and standards).

In some implementations, apparatus 200 may include a memory 220. Memory 220 may be a storage device configured to store one or more sets of codes, programs and/or instructions 222 as well as data 224 therein. For example, memory 220 may be operatively coupled to processor 210 to receive data 224. Memory 220 may be implemented by any suitable technology and may include volatile memory and/or non-volatile memory. For example, memory 220 may include a type of random-access memory (RAM) such as dynamic RAM (DRAM), static RAM (SRAM), thyristor RAM (T-RAM) and/or zero-capacitor RAM (Z-RAM). Alternatively, or additionally, memory 220 may include a type of read-only memory (ROM) such as mask ROM, programmable ROM (PROM), erasable programmable ROM (EPROM) and/or electrically erasable programmable ROM (EEPROM). Alternatively, or additionally, memory 220 may include a type of non-volatile random-access memory (NVRAM) such as flash memory, solid-state memory, ferroelectric RAM (FeRAM), magnetoresistive RAM (MRAM) and/or phase-change memory.

Processor 210 may be implemented in the form of one or more single-core processors, one or more multi-core processors, or one or more CISC processors. That is, processor 210 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure, including over-the-air calibration of transmit power of wireless devices.

Processor 210 may access memory 220 to execute the one or more instructions stored in memory 220. Upon executing the one or more sets of instructions, processor 210 may be configured to perform operations pertaining to over-the-air calibration of transmit power of wireless devices in accordance with the present disclosure. In some implementations, processor 210 may include a control circuit 215 capable of performing operations pertaining to over-the-air calibration of transmit power of wireless devices in accordance with the present disclosure. For instance, when apparatus 200 is implemented as testing instrument 110 in scenario 100, control circuit 215 may measure, via communication device 230, one or more parameters related to transmit power in a first wireless signal transmitted by a wireless device (e.g., DUT 120 in scenario 100). Moreover, control circuit 215 may transmit, via communication device 230, to the wireless device a second wireless signal containing data of a result of measurement of the one or more parameters.

In some implementations, in transmitting the second wireless signal containing the data of the result of measurement of the one or more parameters, control circuit 215 may transmit a generic frame in accordance with the IEEE 802.11 specification(s) and containing the data of the result of measurement of the one or more parameters.

In some implementations, the one or more parameters related to the transmit power in the first wireless signal transmitted by the wireless device may include one or more of the following: a peak transmit power, a channel power, and an error vector magnitude (EVM) data. Such parameters are related to the transmit power in the first wireless signal transmitted by the wireless device.

In some implementations, in measuring the one or more parameters related to the transmit power in the first wireless signal transmitted by the wireless device, control circuit 215 may wirelessly receive, via communication device 230, a single data frame from the wireless device. In some implementations, the single data frame may include a data frame in accordance with the IEEE 802.11 specification(s).

In some implementations, in measuring the one or more parameters related to the transmit power in the first wireless signal transmitted by the wireless device, control circuit 215 may wirelessly receive, via communication device 230, multiple data frames from the wireless device. In some implementations, each of the multiple data frames may include a data frame in accordance with the IEEE 802.11 specification(s).

In some implementations, in measuring the one or more parameters related to the transmit power in the first wireless signal transmitted by the wireless device, control circuit 215 may measure respective one or more parameters related to a respective transmit power in a respective first wireless signal transmitted by each of a plurality of wireless devices. In some implementations, in transmitting the second wireless signal containing the data of the result of measurement of the one or more parameters, control circuit 215 may transmit, via communication device 230, to each of the plurality of wireless devices a respective second wireless signal containing respective data of a result of measurement of the respective one or more parameters. In some implementations, in transmitting to each of the plurality of wireless devices a respective second wireless signal, control circuit 215 may transmit to each of the plurality of wireless devices respectively a generic frame in accordance with the IEEE 802.11 specification(s) and containing the respective data of the result of measurement of the respective one or more parameters.

### Illustrative Processes

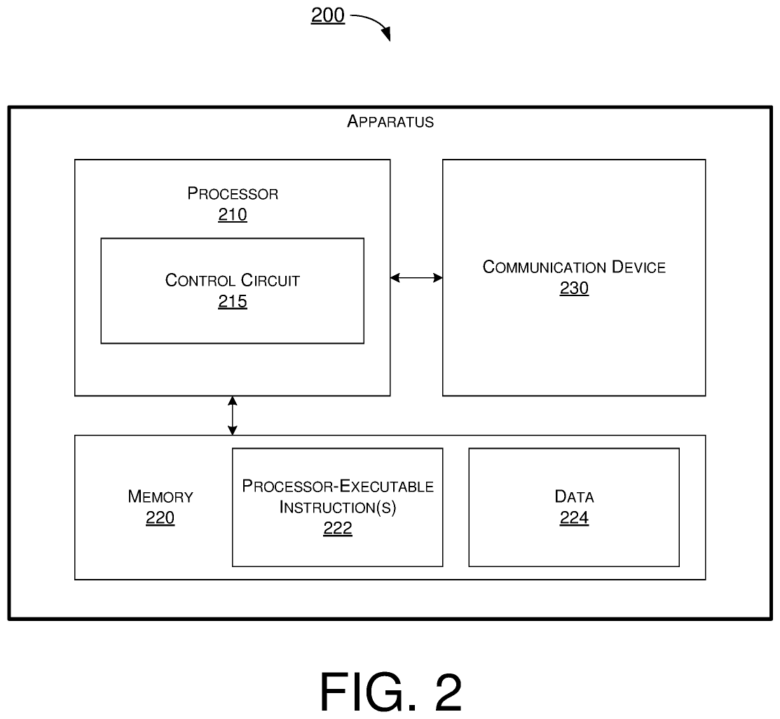

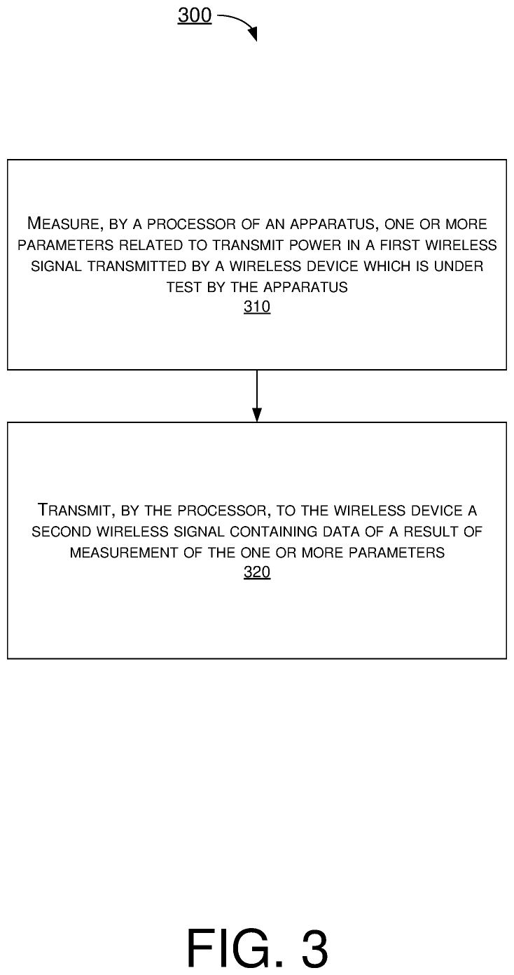

FIG. 3 illustrates an example process 300 in accordance with an implementation of the present disclosure. Process 300 may represent an aspect of implementing various proposed designs, concepts, schemes, systems and methods described above, whether partially or entirely, including those pertaining to FIG. 1 and FIG. 2. More specifically, process 300 may represent an aspect of the proposed concepts and schemes pertaining to over-the-air calibration of transmit power of wireless devices. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 200 as well as any variations thereof. Solely for illustrative purposes and without limiting the scope, process 300 is described below in the context of apparatus 200 functioning as testing instrument 110 in scenario 100. Process 300 may begin at block 310.

At 310, process 300 may involve processor 210 of apparatus 200 (e.g., testing instrument 110) measuring, via communication device 230, one or more parameters related to transmit power in a first wireless signal transmitted by a wireless device (e.g., DUT 120 in scenario 100) which is under test by the apparatus. Process 300 may proceed from 310 to 320.

At 320, process 300 may involve processor 210 transmitting, via communication device 230, to the wireless device a second wireless signal containing data of a result of measurement of the one or more parameters.

In some implementations, in transmitting the second wireless signal containing the data of the result of measurement of the one or more parameters, process 300 may involve processor 210 transmitting a generic frame in accordance with the 802.11 specification(s) and containing the data of the result of measurement of the one or more parameters.

In some implementations, the one or more parameters related to the transmit power in the first wireless signal transmitted by the wireless device may include one of the following: a peak transmit power, a channel power, and an error vector magnitude (EVM) data. Such parameters are related to the transmit power in the first wireless signal transmitted by the wireless device.

In some implementations, in measuring the one or more parameters related to the transmit power in the first wireless signal transmitted by the wireless device, process 300 may involve processor 210 wirelessly receiving, via communication device 230, a single data frame from the wireless device. In some implementations, the single data frame may include a data frame in accordance with the IEEE 802.11 specification(s).

In some implementations, in measuring the one or more parameters related to the transmit power in the first wireless signal transmitted by the wireless device, process 300 may involve processor 210 wirelessly receiving, via communication device 230, multiple data frames from the wireless device. In some implementations, each of the multiple data frames may include a data frame in accordance with the IEEE 802.11 specification(s).

In some implementations, in measuring the one or more parameters related to the transmit power in the first wireless signal transmitted by the wireless device, process 300 may involve processor 210 measuring respective one or more parameters related to a respective transmit power in a respective first wireless signal transmitted by each of a plurality of wireless devices. In some implementations, in transmitting the second wireless signal containing the data of the result of measurement of the one or more parameters, process 300 may involve processor 210 transmitting, via communication device 230, to each of the plurality of wireless devices a respective second wireless signal containing respective data of a result of measurement of the respective one or more parameters. In some implementations, in transmitting to each of the plurality of wireless devices a respective second wireless signal, process 300 may involve processor 210 transmitting to each of the plurality of wireless devices respectively a generic frame in accordance with the IEEE 802.11 specification(s) and containing the respective data of the result of measurement of the respective one or more parameters.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
measuring, by a processor of an apparatus, one or more parameters related to transmit power in a first wireless signal transmitted by a wireless device which is under test by the apparatus; and
transmitting, by the processor, to the wireless device a second wireless signal containing data of a result of measurement of the one or more parameters.

2. The method of claim 1, wherein the transmitting of the second wireless signal containing the data of the result of measurement of the one or more parameters comprises transmitting a generic frame in accordance with an Institute of Electrical and Electronics Engineers (IEEE) 802.11 specification and containing the data of the result of measurement of the one or more parameters.

3. The method of claim 1, wherein the one or more parameters related to the transmit power in the first wireless signal transmitted by the wireless device comprises a peak transmit power, a channel power, an error vector magnitude (EVM) data, or a combination thereof, related to the transmit power in the first wireless signal transmitted by the wireless device.

4. The method of claim 1, wherein the measuring of the one or more parameters related to the transmit power in the first wireless signal transmitted by the wireless device comprises wirelessly receiving a single data frame from the wireless device.

5. The method of claim 4, wherein the single data frame comprises a data frame in accordance with an Institute of Electrical and Electronics Engineers (IEEE) 802.11 specification.

6. The method of claim 1, wherein the measuring of the one or more parameters related to the transmit power in the first wireless signal transmitted by the wireless device comprises wirelessly receiving multiple data frames from the wireless device.

7. The method of claim 6, wherein each of the multiple data frames comprises a data frame in accordance with an Institute of Electrical and Electronics Engineers (IEEE) 802.11 specification.

8. The method of claim 1, wherein the measuring of the one or more parameters related to the transmit power in the first wireless signal transmitted by the wireless device comprises measuring respective one or more parameters related to a respective transmit power in a respective first wireless signal transmitted by each of a plurality of wireless devices.

9. The method of claim 8, wherein the transmitting of the second wireless signal containing the data of the result of measurement of the one or more parameters comprises transmitting to each of the plurality of wireless devices a respective second wireless signal containing respective data of a result of measurement of the respective one or more parameters.

10. The method of claim 9, wherein the transmitting to each of the plurality of wireless devices a respective second wireless signal comprises transmitting to each of the plurality of wireless devices respectively a generic frame in accordance with an Institute of Electrical and Electronics Engineers (IEEE) 802.11 specification and containing the respective data of the result of measurement of the respective one or more parameters.

11. An apparatus, comprising:
a transceiver which, during operation, wirelessly receive and transmit signals with a wireless device which is under test by the apparatus; and
a processor coupled to the transceiver such that, during operation, the processor performs operations comprising:
measuring, via the transceiver, one or more parameters related to transmit power in a first wireless signal transmitted by the wireless device; and
transmitting, via the transceiver, to the wireless device a second wireless signal containing data of a result of measurement of the one or more parameters.

12. The apparatus of claim 11, wherein, in transmitting the second wireless signal containing the data of the result of measurement of the one or more parameters, the processor transmits a generic frame in accordance with an Institute of Electrical and Electronics Engineers (IEEE) 802.11 specification and containing the data of the result of measurement of the one or more parameters.

13. The apparatus of claim 11, wherein the one or more parameters related to the transmit power in the first wireless signal transmitted by the wireless device comprises a peak transmit power, a channel power, an error vector magnitude (EVM) data, or a combination thereof, related to the transmit power in the first wireless signal transmitted by the wireless device.

14. The apparatus of claim 11, wherein, in measuring the one or more parameters related to the transmit power in the first wireless signal transmitted by the wireless device, the processor wirelessly receives a single data frame from the wireless device.

15. The apparatus of claim 14, wherein the single data frame comprises a data frame in accordance with an Institute of Electrical and Electronics Engineers (IEEE) 802.11 specification.

16. The apparatus of claim 11, wherein, in measuring the one or more parameters related to the transmit power in the first wireless signal transmitted by the wireless device, the processor wirelessly receives multiple data frames from the wireless device.

17. The apparatus of claim 16, wherein each of the multiple data frames comprises a data frame in accordance with an Institute of Electrical and Electronics Engineers (IEEE) 802.11 specification.

18. The apparatus of claim 11, wherein, in measuring the one or more parameters related to the transmit power in the first wireless signal transmitted by the wireless device, the processor measures respective one or more parameters related to a respective transmit power in a respective first wireless signal transmitted by each of a plurality of wireless devices.

19. The apparatus of claim 18, wherein, in transmitting the second wireless signal containing the data of the result of measurement of the one or more parameters, the processor transmits to each of the plurality of wireless devices a respective second wireless signal containing respective data of a result of measurement of the respective one or more parameters.

20. The apparatus of claim 19, wherein, in transmitting to each of the plurality of wireless devices a respective second wireless signal, the processor transmits to each of the plurality of wireless devices respectively a generic frame in accordance with an Institute of Electrical and Electronics Engineers (IEEE) 802.11 specification and containing the respective data of the result of measurement of the respective one or more parameters.
